(19) United States
(12) Patent Application Publication
(10) Pub. No.: US 2009/0291325 A1
(43) Pub. Date: Nov. 26, 2009

(54) Phosphazene Compound, Lubricant and Magentic Recording Medium Having Such Compound, Method of Preparation, and Method of Lubrication

(75) Inventors: Jianwei Xu, Singapore (SG); Jun Zhang, Singapore (SG); Shaofeng Wang, Singapore (SG); Kok-Peng Joseph Ng, Singapore (SG); Rong Ji, Singapore (SG); Baoxi Xu, Singapore (SG); Shengbin Hu, Singapore (SG)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: AGENCY FOR SCIENCE, TECHNOLOGY AND RESEARCH, (SG)

(21) Appl. No.: 12/373,566

(22) PCT Filed: Jul. 13, 2006
(86) PCT No.: PCT/SG06/00198

§ 371 Date: Jan. 13, 2009

(51) Int. Cl. G11B 5/00; C07F 9/547; B05D 5/00

(52) U.S. Cl. 428/800; 564/13; 427/127

(57) ABSTRACT

A compound of the formula: (I) is provided, where R is selected from CF₃, F, and H, and m is an integer from 1 to 22. The compound may be prepared by reacting a first reactant with a second reactant in a solution, where the first reactant is a 2,4-dichloro-2,4,6,6-tetra(aryloxy)-1,3,5-triaza-2,4,6-triphosphorine, and the second reactant is a perfluoropolyether of the formula CF₃CF₂CF₂O(CF₂CF₂CF₂O)ₘCF₂CF₂CH₂OH. The aryloxy is selected from 4-(trifluoromethyl)phenoxy (p-CF₃—C₆H₄O), 4-fluorophenoxy (p-F—C₆H₄O), and phenoxy (C₆H₅O). The first reactant may be prepared by reacting 2,2,4,4,6,6-hexachloro-1,3,5-triaza-2,4,6-triphosphorine with a phenoxide. The compound may be used in a lubricant for lubricating a surface. The lubricant may be applied to a recording surface in a magnetic recording device including a recording medium.

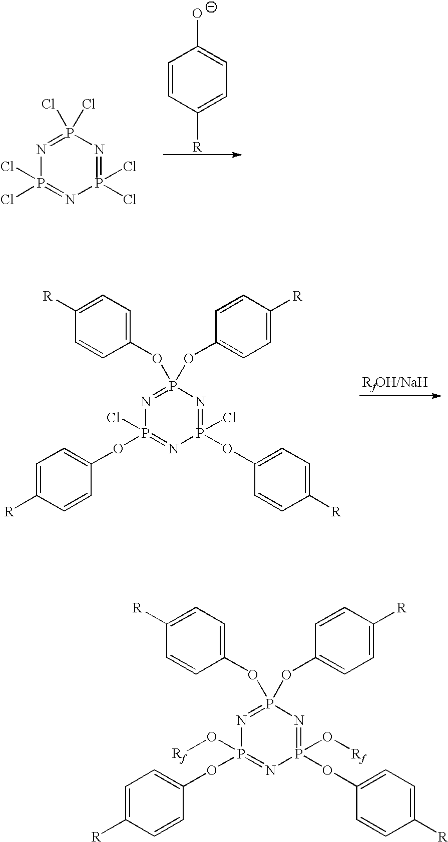

### FIELD OF THE INVENTION

The present invention relates to phosphazene compounds, methods of preparing such compounds, lubricants and magnetic recording medium having such compounds, and methods of lubricating a surface.

### BACKGROUND OF THE INVENTION

Various phosphazene compounds have been used as lubricants, such as for magnetic recording applications. Some of the conventional phosphazene compounds include fluorinated or perfluoroalkyl aromatic groups and hydroxyl-terminated perfluoropolyether (PFPE) chains. While the conventional phosphazene lubricants have been found useful in many applications, alternative and improved lubricants are still desirable. For example, compounds with reduced dynamical frictional coefficients and improved thermal stability are desirable for lubricants used in magnetic recording applications, such as heat assisted magnetic recording (HAMR) devices including recording medium. Other desirable improvements for lubricants used in magnetic recording applications include improved corrosion resistance and better balanced mobility.

### SUMMARY OF THE INVENTION

Therefore, in accordance with an aspect of the present invention, there is provided a compound of the formula:

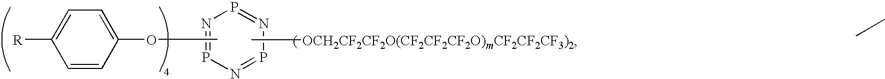

where R is selected from CF₃, F, and H, and m is an integer from 1 to 22, such as from 10 to 12. In a particular embodiment, R is CF₃.

In accordance with another aspect of the present invention, there is provided a method for preparing the compound described in the preceding paragraph. The method comprises reacting a first reactant with a second reactant in a solution to form the compound. The first reactant is a 2,4-dichloro-2,4,6,6-tetra(aryloxy)-1,3,5-triaza-2,4,6-triphosphorine, and the second reactant is a perfluoropolyether of the formula CF₃CF₂CF₂O(CF₂CF₂CF₂O)ₘCF₂CF₂CH₂OH. The aryloxy is selected from 4-(trifluoromethyl)phenoxy (p-CF₃—C₆H₄O), 4-fluorophenoxy (p-F—C₆H₄O), and phenoxy (C₆H₅O). The solution may include a solvent comprising tetrahydrofuran. The solution may also include a perfluorinated solvent. The first reactant may be prepared by reacting 2,2,4,4,6,6-hexachloro-1,3,5-triaza-2,4,6-triphosphorine with a phenoxide. The phenoxide may be prepared by reacting a phenol with a base in a solution. The base may be selected from sodium hydride, potassium hydroxide, potassium carbonate, and sodium hydroxide. The compound may be prepared by mixing 2,2,4,4,6,6-hexachloro-1,3,5-triaza-2,4,6-triphosphorine, the second reactant, a phenol, and sodium hydride in a solution, where the solution comprises a perfluorinated solvent and tetrahydrofuran.

In accordance with a further aspect of the present invention, there is provided a method of lubricating a surface. In this method, an effective amount of the compound described above is applied to the surface to lubricate the surface. The surface may be a recording surface of a magnetic recording device. The magnetic recording device may be a magnetic recording medium. The magnetic recording medium may include a rotating magnetic recording medium selected from a longitudinal recording medium, a perpendicular recording medium, a patterned recording medium, and a heat assisted magnetic recording medium.

In accordance with a further aspect of the present invention, there is provided a lubricant comprising the compound described above. The lubricant may be for a magnetic recording medium. The magnetic recording medium may include a rotating magnetic recording medium selected from a longitudinal recording medium, a perpendicular recording medium, a patterned recording medium, and a heat assisted magnetic recording medium.

In accordance with a further aspect of the present invention, there is provided a magnetic recording device having a recording surface and a lubricant described above on the recording surface. The device may be a magnetic recording medium. The magnetic recording medium may be a rotating magnetic recording medium selected from a longitudinal recording medium, a perpendicular recording medium, a patterned recording medium, and a heat assisted magnetic recording medium. The magnetic recording device may include a hard disk drive.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1A is a schematic top plan view of a magnetic recording device including a magnetic recording medium;

FIG. 1B is a schematic side view of the magnetic recording medium of FIG. 1A;

FIG. 2 is a schematic diagram of a chemical reaction process;

FIGS. 3 and 4 are respectively line graphs of measured weight loss as a function of temperature for different lubricants;

FIG. 5 is a line graph of measured frictional coefficients for different lubricants;

FIGS. 6A and 6B are bar graphs of measured corrosion products for different lubricants;

FIGS. 7 to 9 are respectively line graphs with surface images showing lubricant film recovery for different lubricants measured with time-of-flight secondary ion mass spectroscopy (TOF-SIMS); and

FIG. 10 is a bar graph of measured water contact angles for different lubricants.

### DETAILED DESCRIPTION

An exemplary embodiment of the present invention is a compound of the formula (I):

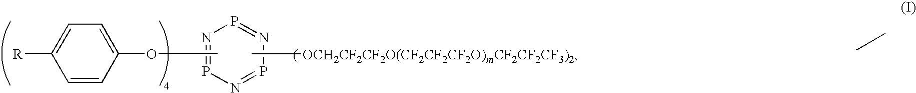

where R is selected from CF₃, F, and H, and m is an integer from 1 to 22. In a specific embodiment, R is CF₃. In some embodiments, m may be from 1 to 10.

The compounds of formula (I) are PFPE covalently-linked cyclotriphosphazenes. Each compound of formula (I) has four substituted aromatic groups and two PFPE chains. The aromatic groups include para-trifluoromethyl phenoxy, para-fluorophenoxy, or phenoxy groups. The PFPE chains do not have any terminal hydroxyl group. According to conventional naming schemes, the compounds of formula (I) can be respectively referred to as 2,4-di(PFPE-O)-2,4,6,6-tetra(4-(trifluoromethyl)phenoxy)-1,3,5-triaza-2,4,6-triphosphorine (when R is CF₃), 2,4-di(PFPE-O)-2,4,6,6-tetra(4-fluorophenoxy)-1,3,5-triaza-2,4,6-triphosphorine (when R is F), and 2,4-di(PFPE-O)-2,4,6,6-tetra(phenoxy)-1,3,5-triaza-2,4,6-triphosphorine (when R is H).

It has been discovered that the compounds of formula (I) may be used in lubricants and the resulting lubricants have improved properties and characteristics over conventional lubricants used in magnetic recording applications. For example, as will be discussed further below, among other improved properties, lubricants containing these compounds can have a relatively low dynamical friction coefficient and relatively high thermal stability, as compared to some conventional lubricants. Lubricants according to embodiments of the present invention may also have good corrosion resistance and balanced mobility.

Thus, in an exemplary embodiment of the present invention, a lubricant is provided which contains a phosphazene compound of the formula (I). The lubricant may also contain other suitable chemicals or additives such as PFPE. The lubricant may be used in a magnetic recording device or application, such as a magnetic recording medium including a computer disk. The lubricant may be applied to a recording surface of the magnetic recording medium. The magnetic recording device or application may utilize a HAMR technique. As can be appreciated, in a HAMR application or device, a lubricant with high thermal stability may be advantageous, because the temperature at the recording surface of a HAMR device or medium can cycle between the room temperature and a temperature in the range of 250 to 650° C. within a cycling period of nanoseconds. As can be appreciated, the lubricant may be used in any suitable magnetic recording applications, with any suitable recording medium or other devices. For example, the lubricant can be used for a rotating magnetic recording medium including a longitudinal recording medium, a perpendicular recording medium, a patterned recording medium, and a heat assisted magnetic recording medium, and the like. The magnetic recording medium may be used for small form factor drives.

Further, the lubricant may be used in other, either similar or different, applications. For example, the lubricant may be advantageously used in any suitable application where high thermal stability and low dynamic frictional coefficient are desired.

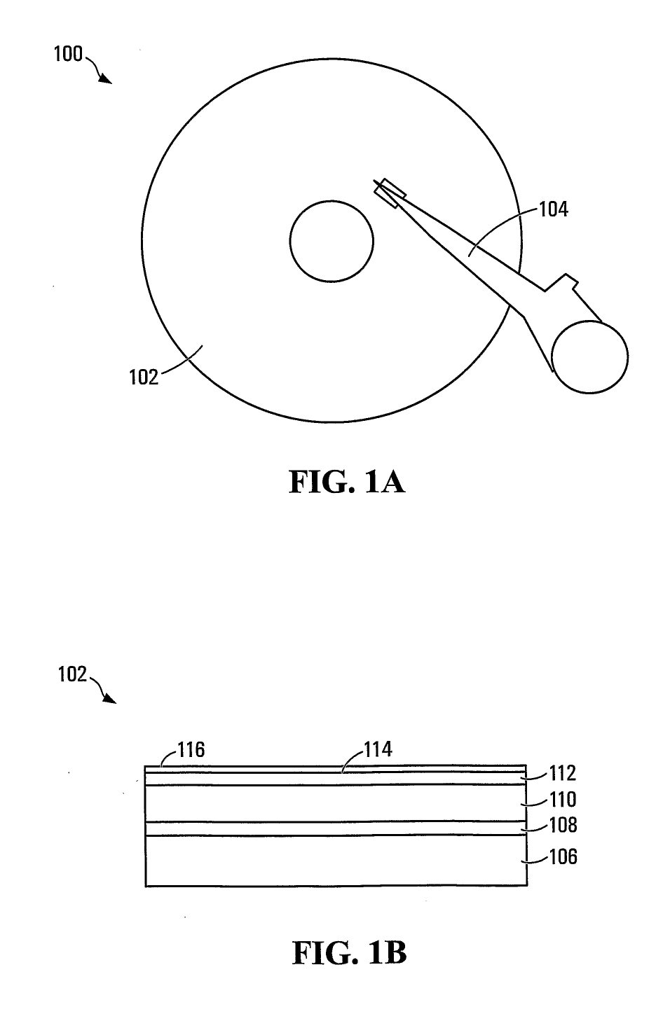

FIG. 1A illustrates a magnetic recording device 100, which includes a magnetic recording medium 102 and a magnetic recording head 104. Magnetic recording device 100 may be a disk drive such as a hard disk drive, where head 104 is used for reading from and writing to magnetic recording medium 102. As illustrated, magnetic recording medium 102 may have the shape of a disk and can rotate about a central axis.

Magnetic recording medium 102 may have any suitable structure and may be made of any suitable material as can be understood by one skilled in the art. An exemplary embodiment of magnetic recording medium 102 is shown in FIG. 1B. As shown, magnetic recording medium 102 may have a multilayer structure and include a substrate 106, an underlayer 108, a magnetic layer 110, and a protective layer 112 such as carbon overcoat which has a surface 114. Recording head 104 will move across surface 114 for reading and writing data. Thus, surface 114 is a recording surface from which data is read from or written to the recording medium. A lubricant containing an effective amount of the compound of formula (I) is deposited on surface 114. The lubricant may be applied to surface 114 using a dip coating method or a vapor phase deposition method. Surface 114 may be specially sputtered for good affinity to the lubricant. Other materials may be added to the lubricant as additives to further improve the lubricant's performance. The lubricant may be applied on surface 114 to form a thin film 116. Film 116 may have a thickness on the order of 0.5 to 10 nm, such as about 1 to 2 nm.

Head 104 may be any suitable reading/writing head and may include a Head-Gimbal-Assembly (HGA).

Device 100 may also include other components. For example, in a disk drive, a spindle motor (not shown) may be included for spinning the disk.

During use, head 104 may move relative to recording medium 102. For example, in a disk drive, the disk may spin around, so that different memory addresses can be accessed by head 104. Head 104 may contact lubricant film 116 during such relative movement. As film 116 has a low dynamic frictional coefficient, it lubricates the recording surface 114 to reduce friction between recording surface 114 and head 104.

It has also been discovered that the compounds of formula (I) may be prepared by the following method, exemplary of an embodiment of the present invention. In this method, the selected compound of formula (I) is prepared by reacting a first reactant with a second reactant in a solution. The first reactant is 2,4-dichloro-2,4,6,6-tetra(aryloxy)-1,3,5-triaza-2,4,6-triphosphorine, where the aryloxy may be selected from phenoxy (C₆H₅O), 4-fluorophenoxy (p-F—C₆H₄O), and 4-(trifluoromethyl)phenoxy (p-CF₃—C₆H₄O), depending on the compound to be formed. The second reactant is a perfluoropolyether with one terminal hydroxyl group, having the form of R_{f}OH. R_{f} has the formula of CF₃CF₂CF₂O(CF₂CF₂CF₂O)ₘCF₂CF₂CH₂, where “m” is an integer from 1 to 22, such as from 10 to 12. As can be appreciated, R_{f}OH has a molecular weight from about 400 to about 4000. The value of “m” may be selected depending on the desired resulting compound.

The solution may include two immiscible solvents, such as tetrahydrofuran (THF) and a perfluorinated solvent. The THF may be replaced by another suitable solvent such as benzene, methylbenzene, or the like. The perfluorinated solvent may be selected from FC-77™, HFE 7100™, PF5060™, and the like. Some of these solvents are commercially available from Dupont™ or 3M™ Novec™. A suitable solvent in the Vertrel™ family of solvents may also be used.

The first reactant may be prepared by reacting a third reactant with a corresponding phenoxide in a solution, where the third reactant is 2,2,4,4,6,6-hexachloro-1,3,5-triaza-2,4,6-triphosphorine. The phenoxide may be prepared by reacting a phenol with a base. The base may be selected from sodium hydride, potassium hydroxide, sodium hydroxide, potassium carbonate, or the like. In one specific exemplary embodiment, the base is sodium hydride.

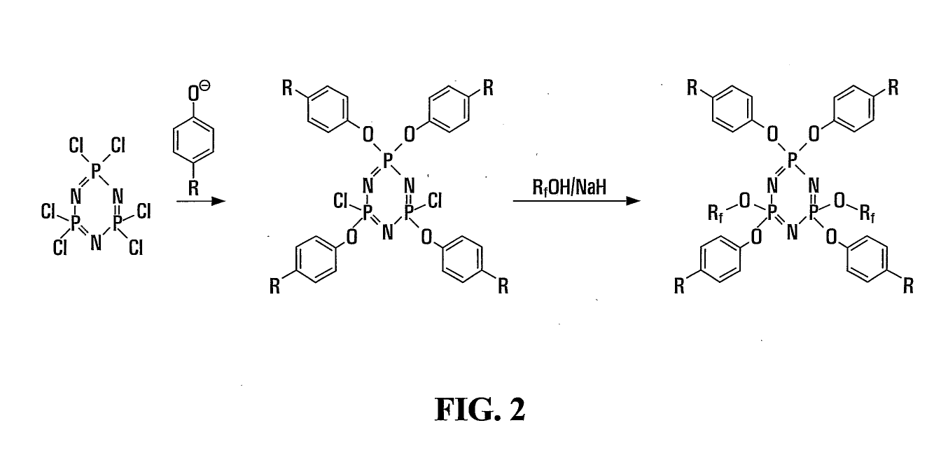

In a specific exemplary embodiment, a compound of formula (I) may be prepared by mixing the second and third reactants, a corresponding phenol, and sodium hydride in a solution with a perfluorinated solvent and THF as the solvents. It is expected that the reactions in the solution proceed as illustrated in FIG. 2, where R is CF₃, F, or H. The phenol and sodium hydride react in the solution to form a corresponding phenoxide. The phenoxide then reacts with the third reactant to form the first reactant, as shown in the first reaction of FIG. 2. The first reactant formed reacts with the second reactant (R_{f}OH) in the presence of sodium hydride (NaH) to form the desired phosphazene compound, as shown in the second reaction of FIG. 2. The phosphazene compound may be then extracted from the solution. Conventional purification techniques may be used during synthesis of the compound, as can be understood by one skilled in the art.

It can be understood that the first reaction step of FIG. 2 may be conducted in THF, benzene or methylbenzene. For example, the first reaction step may be carried out in THF. The product of the first reaction extracted and purified from the first solution is then reacted with RFOH in the presence of NaH in a mixture of perfluorinated solvent and THF. Alternatively, a perflourinated solvent and R_{f}ONa may be added to the THF solution with a purified tetra-substituted intermediate obtained from the first step.

As can be understood, in the exemplary process described above, the ratio of the number of substituted aromatic groups and the number of PFPE chains in the resulting compounds is conveniently controlled to be exactly 4:2.

The compounds of formula (I) can be readily formed or incorporated into a lubricant by a person skilled in the art using suitable techniques, including conventional lubricant producing techniques. Similarly, any suitable technique of applying a lubricant to a magnetic recording medium or device may be used to apply a lubricant of the present invention to a magnetic recording medium or device, including techniques currently known to persons skilled in the art.

In an exemplary process of forming a thin lubricant film on a surface, a diluted liquid may be prepared by dissolving the lubricant compound in a suitable solvent such as PF5060, HFE7100, or a suitable solvent in the Vertrel family of solvents. The recording medium is dipped into the liquid and then withdrawn from the liquid so that the surface of the recording medium is coated with the fluid. The coated fluid is allowed to dry. When the solvent is sufficiently evaporated, a layer of the lubricant stays on the medium surface. The thickness of the lubricant layer can be controlled by adjusting the concentration of the lubricant compound in the liquid or the dipping rate, or both.

Some specific examples are described next to further illustrate exemplary embodiments of the present invention.

### EXAMPLES

### Example I

In Example I, 2,4-dichloro-2,4,6,6-tetra(4-(trifluoromethyl)phenoxy)-1,3,5-triaza-2,4,6-triphosphorine was synthesized in the following procedure.

A first solution was prepared, which contained 200 ml of dry THF and 20.0 g (123.37 mmol) of 4-(trifluoromethyl)phenol. About 4.94 g of sodium hydride (123.43 mmol, as a 60% dispersion in mineral oil) were added in small portions to the first solution to form sodium 4-(trifluoromethyl)phenoxide.

A second solution was prepared at about room temperature by dissolving 10.72 g (30.84 mmol) of 2,2,4,4,6,6-hexachloro-1,3,5-triaza-2,4,6-triphosphorine in 100 ml dry THF.

The sodium 4-(trifluoromethyl)phenoxide formed from the first solution was added drop-wise to the second solution at 0° C. to form a mixture. The mixture solution was stirred during addition of sodium 4-(trifluoromethyl)phenoxide.

The mixture was warmed to room temperature and was stirred for 24 hours. The THF in the mixture was then removed from the mixture by rotary evaporation. The oily residue was dissolved in chloroform, which was washed with, in succession, water, a dilute aqueous hydrochloric acid, water, and brine, to remove un-reacted starting materials and water-soluble side-products.

Residual water in chloroform layer is then removed with a drying agent, anhydrous MgSO₄. After drying, the drying agent was filtered out and the chloroform was removed under reduced pressure, resulting in a crude liquid product.

The crude liquid products contained 2,4,6-trichloro-2,4,6-tri(4-(trifluoromethyl)phenoxy)-1,3,5-triaza-2,4,6-triphosphorine, 2,4-dichloro-2,4,6-tetra(4-(trifluoromethyl)phenoxy)-1,3,5-triaza-2,4,6-triphosphorine, and 2-chloro-2,4,4,6,6-penta(4-(trifluoromethyl)phenoxy)-1,3,5-triaza-2,4,6-triphosphorine. The composition of the crude products was analyzed using thin layer chromatography.

The crude products were purified by column chromatography using a mixture of chloroform/hexane of a volume ratio of 1:3 as the eluent. The purified product contained 2,4-dichloro-2,4,6,6-tetra(4-(trifluoromethyl)phenoxy)-1,3,5-triaza-2,4,6-triphosphorine, which was a viscous liquid. The resulting product weighed about 11.67 g, giving a yield of about 45%.

### Example II

In Example II, 2,4-dichloro-2,4,6,6-tetra(4-fluorophenoxy)-1,3,5-triaza-2,4,6-triphosphorine was synthesized in the following procedure.

A first solution was prepared by adding 13.50 g (120.4 mmol) of 4-fluorophenol to 100 ml of dry THF. About 4.90 g (122.5 mmol, 60% dispersion in mineral oil) of sodium hydride were added in small portions to the first solution to form sodium 4-fluorophenoxide.

A second solution was prepared by adding 2,2,4,4,6,6-hexachloro-1,3,5-triaza-2,4,6-triphosphorine (10.0 g, 28.8 mmol) to 100 ml of dry THF.

The sodium 4-fluorophenoxide formed from the first solution was added drop-wise to the second solution at 0° C. to form a mixture. The second solution was stirred during the addition.

The mixture was processed in the same way as in Example I to obtain a crude product. The crude product contained 2,4,6-trichloro-2,4,6-tri(4-fluorophenoxy)-1,3,5-triaza-2,4,6-triphosphorine, 2,4-dichloro-2,4,6-tetra(4-fluorophenoxy)-1,3,5-triaza-2,4,6-triphosphorine, and 2-chloro-2,4,4,6,6-penta(fluorophenoxy)-1,3,5-triaza-2,4,6-triphosphorine. The composition of the crude product was analyzed using thin layer chromatography. The crude products were purified in the same way as in Example I. The purified products contained 2,4-dichloro-2,4,6,6-tetra(4-fluorophenoxy)-1,3,5-triaza-2,4,6-triphosphorine, which was a colorless liquid. About 9.52 g of product was obtained, giving a yield of about 51%.

### Example III

In Example III, 2,4-dichloro-2,4,6,6-tetra(phenoxy)-1,3,5-triaza-2,4,6-triphosphorine was synthesized in the following procedure.

A first solution was prepared by adding 22.74 g (241.62 mmol) of phenol to 100 ml of dry THF. About 9.66 g (241.62 mmol, 60%, dispersion in mineral oil) sodium hydride were added in small portions to the first solution to form sodium phenoxide.

A second solution was prepared by adding 20.0 g (57.53 mmol) of 2,2,4,4,6,6-hexachloro-1,3,5-triaza-2,4,6-triphosphorine to 50 ml of dry THF.

The sodium phenoxide formed from the first solution was added drop-wise to the second solution at 0° C. to form a mixture. The solution was stirred during the addition.

The mixture was processed in the same way as in Example I to obtain a crude product. The crude product contained 2,4,6-trichloro-2,4,6-tri(phenoxy)-1,3,5-triaza-2,4,6-triphosphorine, 2,4-dichloro-2,4,6-tetra(phenoxy)-1,3,5-triaza-2,4,6-triphosphorine, and 2-chloro-2,4,4,6,6-penta(phenoxy)-1,3,5-triaza-2,4,6-triphosphorine. The composition of the crude product was analyzed using thin layer chromatography. The crude products were purified in the same way as in Example I. The purified product contained 2,4-dichloro-2,4,6,6-tetraphenoxy-1,3,5-triaza-2,4,6-triphosphorine, which was a colorless liquid. About 17.5 g of product was obtained, giving a yield of about 53%.

### Example IV

In Example IV, a lubricant, Lubricant I, was synthesized.

50 ml FC-77™ fluid was dried through a 4-Å molecular sieve and added into a 100-ml flask. The flask was equipped with a magnetic stirrer, a reflux condenser and a dropping funnel. About 0.15 g of sodium hydride (60% dispersion in mineral oil) were added in small portions to the flask. About 8.05 g of dried hydroxyl-terminated PFPE were added to the flask. The resulting suspension in the flask was stirred vigorously at room temperature for 24 hours.

About 1.50 g of 2,4-dichloro-2,4,6,6-tetra(4-(trifluoromethyl)phenoxy)-1,3,5-triaza-2,4,6-triphosphorine were prepared as described in Example I and were dissolved in 50 mL dry THF. The resulting solution was added drop-wise at room temperature to the above flask. The mixture in the flask was then stirred at room temperature for 24 hours and refluxed at 75° C. for 3.5 hours.

The FC-77 and THF contents in the flask were removed under reduced pressure. Deionized water was poured into the residue in the flask and the mixture was stirred for half an hour. The product mixture was transferred into a plastic tube and was subject to centrifuging to remove water. The water removal process was performed repeatedly to remove sodium chloride formed during the step described in the preceding paragraph. The residue in the flask was dried under vacuum to remove traces of water. Any excess hydroxyl-terminated perfluoropolyether was also removed by vacuum-distillation. The resulting product (about 6.5 g, 70% yield) is labeled as Lubricant I.

### Example V

In Example V, a second sample lubricant, Lubricant II was synthesized.

The synthesis procedure was similar to that in Example IV. Except that about 0.141 g of sodium hydride and about 9.0 g of dried hydroxyl-terminated PFPE were used to prepare the suspension, and that 1.15 g 2,4-dichloro-2,4,6,6-tetra(4-fluorophenoxy)-1,3,5-triaza-2,4,6-triphosphorine, prepared as described in Example II, were used to prepare the lubricant, Lubricant II. The product weighed about 5.70 g, giving a yield of about 63%.

### Example VI

In Example VI, another sample lubricant, lubricant III was synthesized.

Lubricant III was formed in similar procedure for Example V, except that about 8.0 g of dried hydroxyl-terminated PFPE was used to form the suspension, and that about 0.82 g of 2,4-dichloro-2,4,6,6-tetra(phenoxy)-1,3,5-triaza-2,4,6-triphosphorine prepared as in Example III was used to produce the lubricant, Lubricant III (about 3.2 g, 45% yield).

### Example VII

In Example VII, thin lubricant nanofilms (films having a thickness of the order of nanometers) were respectively prepared from Lubricants I to III, using a dip coating method. The dip coating solution included the respective lubricant and a PF5060 solvent. The film thickness was controlled by varying the lubricant concentration and dipping/withdrawing rate. The uniformity of the films was measured using an optical surface analyzer (OSA). Films prepared from Lubricant I were measured to have a thickness of about 1.2 nm.

In the above examples, the compound for the third reactant used was recrystallized from ethyl acetate before use. The THF used was treated with metallic sodium and distilled before use. The phenol, 4-fluorophenol, 4-(trifluoromethyl)phenol and other chemicals were used as received from Sigma-Aldrich™, with 99% purity grade. Hydroxyl-terminated PFPE (Demnum SA) is commercially available from Daikin™ Industries Ltd.

Comparative Studies:

Some properties of Lubricants I to III were measured and compared with those of conventional lubricants. The conventional lubricants used in the comparison studies were Zdol 2000™ and AM 3001™ obtained from Solvay Solexis™, and A20H™ obtained from Moresco™.

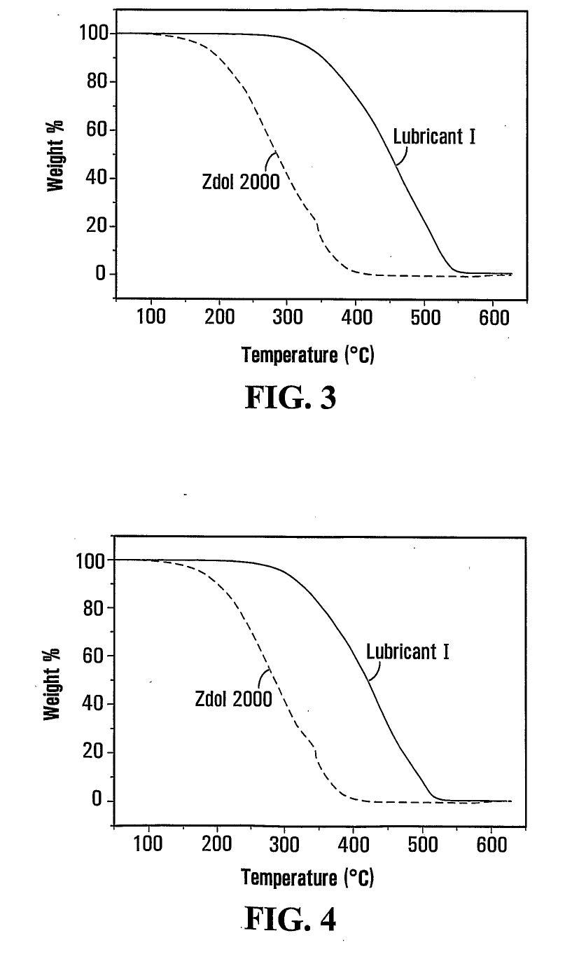

Decomposition test results showed that both Zdol 2000 and AM3001 lubricants exhibited more decomposition upon laser irradiation than those exhibited by Lubricant I. The conventional lubricants started to decompose significantly at much lower temperatures. The measured results for Lubricant I (solid lines) and the Zdol 2000 lubricant (dashed lines) are shown in FIGS. 3 (in N₂) and 4 (in air). Table I lists the measured thermal stabilities of various lubricants. The thermal stabilities of the test lubricants were evaluated using thermogravimetric analysis (TGA). The decomposition temperature (T_{d}) was deemed to be the temperature at which 5% weight loss had occurred after heating. As can be seen in Table I, Lubricants I to III have much higher thermal stability than the Zdol 2000 lubricant. For example, the decomposition temperature of Lubricant I is higher than the Zdol 2000 lubricant by 125° C. and 145° C. respectively in air and in nitrogen.

TABLE I
Thermal stability (T_{d})

| Lubricant | T_{d} in air | T_{d} in nitrogen |
|---|---|---|
| Lubricant I | 301 | 328 |
| Lubricant II | 273 | 298 |
| Lubricant III | 262 | 274 |
| Zdol 2000 | 176 | 183 |

It was further observed, by optical surface analyses, that nanofilms formed from Lubricant I displayed excellent uniformity. In comparison, Zdol 2000 and AM3001 exhibited significant non-uniformity under same deposition conditions. This result suggests that Lubricant I possessed better film formability than both Zdol 2000 and AM3001.

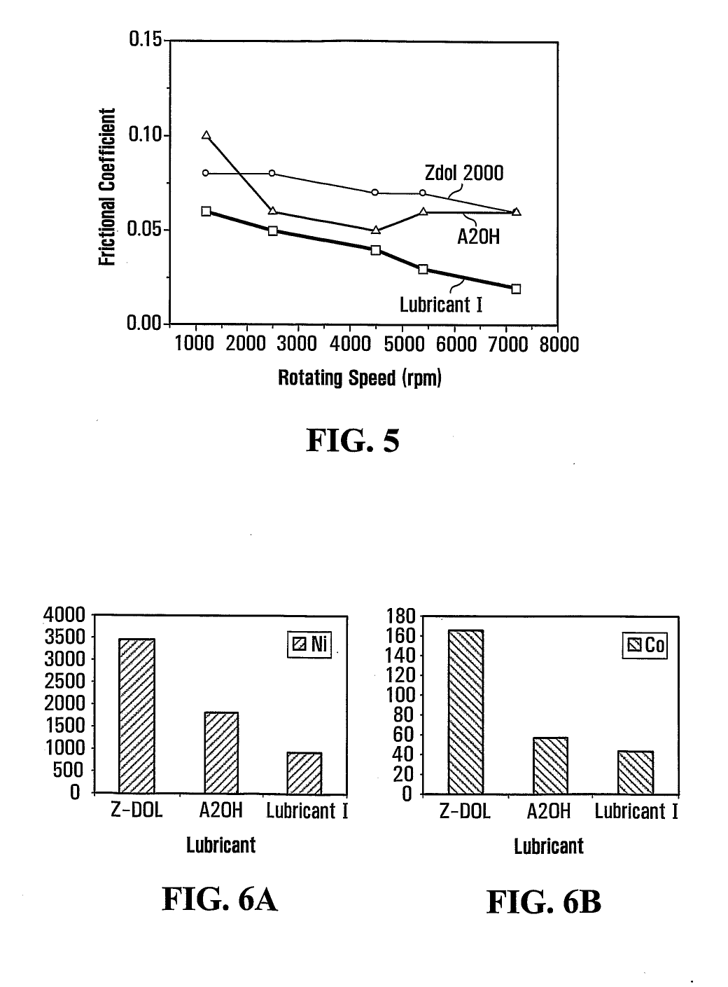

The dynamic friction coefficients of thin films formed from Lubricants I to III, and from Zdol 2000 and A20H lubricants were measured. The films were formed on the surfaces of magnetic hard disks and were measured using a VINA™ contact start stop (CSS) tester attached to an OSA 5100™ optical surface analyzer (skew angle was −1.36°, vertical load was 2.5 g). As illustrated in FIG. 5, the results showed that Lubricant I had lower dynamic friction coefficients than those of the tested conventional lubricants.

Lubricant I also showed higher corrosion resistance, as illustrated in FIGS. 6A and 6B, which shows the amounts of corrosion products (Ni or Co) detected on magnetic medium surfaces lubricated by the respective tested lubricants, after the lubricated surfaces were treated with a 0.5 M acrylic acid solution at 60° C. for 48 hours, respectively. The measurements were made using the TOF-SIMS. As can be seen, the comparison lubricants produced much more corrosion products than Lubricant I did under similar test conditions.

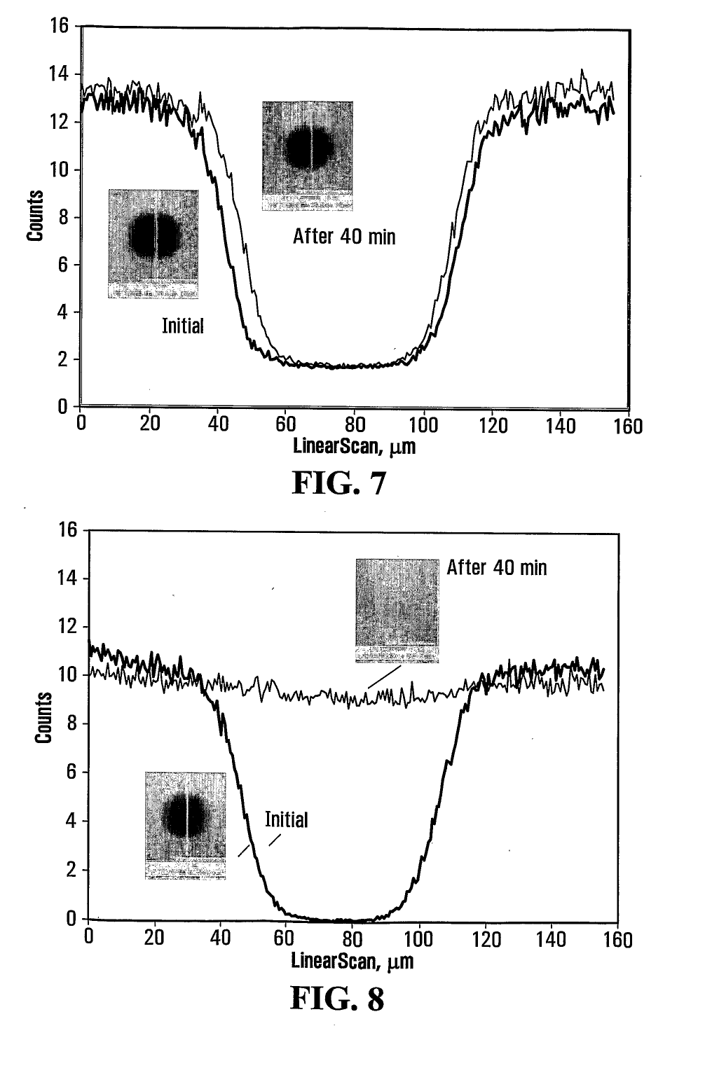

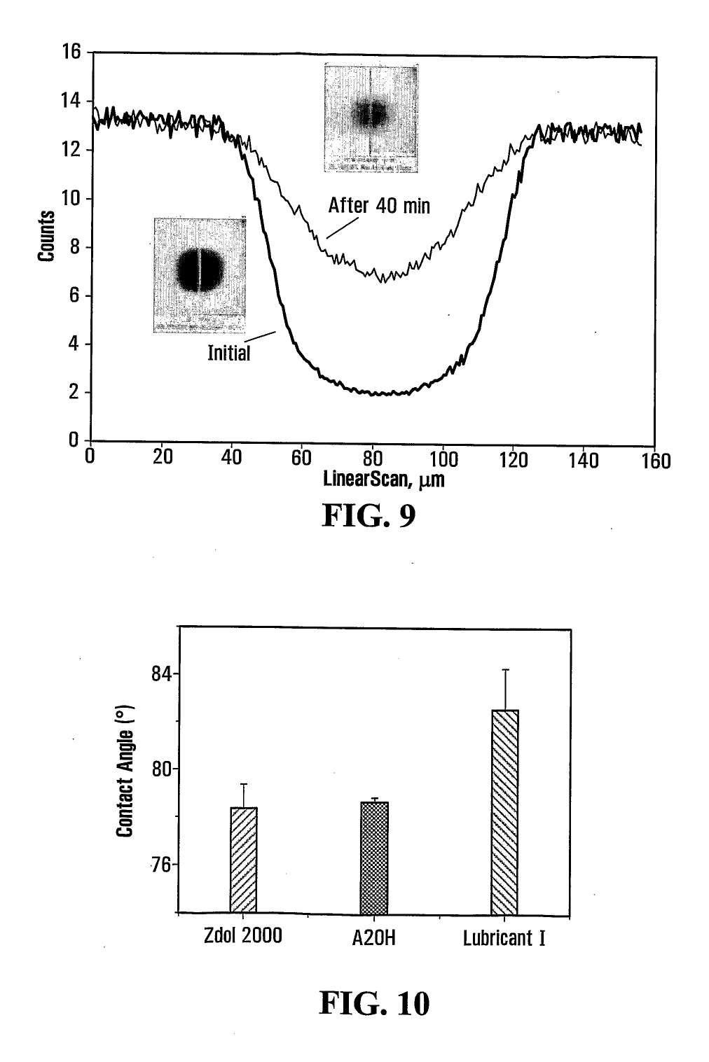

The mobility of the lubricants was also tested. In the tests, a film of each respective lubricant was initially formed uniformly on a disk surface. A local area in the film (a radial “stripe” approximately 10-15 μm wide) was depleted of the lubricant. The rate at which each lubricant film re-flew back into the depleted area on the disk surface was measured using TOF-SIMS. Some example results are shown in FIGS. 7 (for A20H), 8 (for Zdol 2000) and 9 (for Lubricant I), where the recovery by the respective lubricant in the depleted area after 40 minutes was shown. The mobility of A20H film was found to be much lower than that of Zdol 2000 film: the latter showed complete recovery while the former showed little recovery. In comparison, Lubricant I showed a moderate mobility. As can be appreciated, excess mobility may lead to lubricant spin-off and lubricant film dewetting, decreasing the durability of the hard disk, while poor mobility may result in loss of lubrication in some areas on the disk surface. Thus, a moderate mobility may be desirable for a lubricant used in magnetic recording applications.

The water contact angles of the lubricants were also measured using a RameHart™ contact angle goniometer. Under the same measurement conditions, the water contact angle of Lubricant I was found to be higher than that of Zdol 2000 and A20H, as shown in FIG. 10, indicating that lubricant I has lower surface energy. It can be appreciated that a lubricant having contact angles in the range of about 70° to about 90° or higher may be desirable in many applications.

The compound and lubricants described above may also have applications in different fields including high speed motor, high-performance vacuum pump, automotive parts, devices for use under extreme environmental condition such as space exploration devices, and the like.

Other features, benefits and advantages of the embodiments described herein not expressly mentioned above can be understood from this description and the drawings by those skilled in the art.

The contents of each reference cited above are hereby incorporated herein by reference.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

1. A compound of the formula: 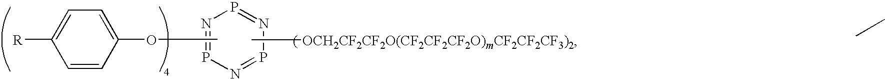
where R is selected from CF₃, F, and H, and m is an integer from 1 to 22.

2. The compound of claim 1, wherein m is from 10 to 12.

3. The compound of claim 1, wherein R is CF₃.

4. A method for preparing the compound of claim 1, comprising:
reacting a first reactant with a second reactant in a solution to form said compound, wherein
said first reactant is a 2,4-dichloro-2,4,6,6-tetra(aryloxy)-1,3,5-triaza-2,4,6-triphosphorine, and
said second reactant is a perfluoropolyether of the formula CF₃CF₂CF₂O(CF₂CF₂CF₂O)ₘCF₂CF₂CH₂OH, said aryloxy selected from 4-(trifluoromethyl)phenoxy (p-CF₃—C₆H₄O), 4-fluorophenoxy (p-F—C₆H₄O), and phenoxy (C₆H₅O).

5. The method of claim 4, wherein said solution comprises a solvent comprising tetrahydrofuran.

6. The method of claim 5, wherein said solution comprises a perfluorinated solvent.

7. The method of claim 4, comprising preparing said first reactant by reacting 2,2,4,4,6,6-hexachloro-1,3,5-triaza-2,4,6-triphosphorine with a phenoxide.

8. The method of claim 4, comprising mixing 2,2,4,4,6,6-hexachloro-1,3,5-triaza-2,4,6-triphosphorine, said second reactant, a phenol, and sodium hydride in a solution, said solution comprising a perfluorinated solvent and tetrahydrofuran.

9. A method of lubricating a surface, comprising applying an effective amount of the compound of claim 1 to said surface to lubricate said surface.

10. The method of claim 9, wherein said surface is a recording surface of a magnetic recording device.

11. The method of claim 10, wherein said magnetic recording device is a magnetic recording medium.

12. The method of claim 11, wherein said magnetic recording medium comprises a rotating magnetic recording medium selected from a longitudinal recording medium, a perpendicular recording medium, a patterned recording medium, and a heat assisted magnetic recording medium.

13. A lubricant comprising the compound of claim 1.

14. A lubricant for a magnetic recording medium, comprising the lubricant of claim 13.

15. The lubricant of claim 14, wherein said magnetic recording medium comprises a rotating magnetic recording medium selected from a longitudinal recording medium, a perpendicular recording medium, a patterned recording medium, and a heat assisted magnetic recording medium.

16. A magnetic recording medium having a recording surface and a lubricant on said recording surface, said lubricant comprising the compound of claim 1.

17. The magnetic recording medium of claim 16, wherein said magnetic recording medium comprises a rotating magnetic recording medium selected from a longitudinal recording medium, a perpendicular recording medium, a patterned recording medium, and a heat assisted magnetic recording medium.

18. A magnetic recording device, comprising the magnetic recording medium of claim 16.

19. The magnetic recording device of claim 18, comprising a hard disk drive.
